(19) United States
(12) Patent Application Publication
(10) Pub. No.: US 2026/0312492 A1
(43) Pub. Date: Oct. 8, 2026

(54) HYBRID SWITCHED CAPACITOR CONVERTER

(71) Applicant: NVIDIA Corporation, Santa Clara, CA (US)

(72) Inventors: Shuai Wang, Shenzen (CN); Huashi Li, Shenzen (CN); Shiwei Cheng, Guangzhou (CN); Weidong He, Guangdong (CN); Qianlong Zhu, Shenzen (CN); Ao Sun, San Jose, CA (US)

(21) Appl. No.: 19/200,956

(22) Filed: May 7, 2025

(30) Foreign Application Priority Data
Apr. 8, 2025 (WO) PCT/CN2025/087784

(51) Int. Cl. H02M 3/07

(52) U.S. Cl. CPC H02M 3/07

(57) ABSTRACT

Devices and methods are disclosed for power conversion using hybrid-switched capacitor converter (HSCC) devices. In at least one embodiment, an HSCC device includes a first power train, a second power train, and a coupling device. The first power train includes a first output terminal. The second power train includes a second output terminal. The coupling device includes, a first input terminal, a second input terminal and, a third output terminal. The first input terminal of the coupling device is connected to the first output terminal, and the second input terminal of the coupling device is connected to the second output terminal. Current from the first and second power trains induces coupling in the coupling device, enhancing performance across different states and various duty cycles.

### CLAIM OF PRIORITY

This application claims the benefit of China International Patent Application No. PCT/CN2025/087784 (Attorney Docket No. 515352) titled “Hybrid Switched Capacitor Converter,” filed Apr. 8, 2025, the entire contents of which is incorporated herein by reference.

### BACKGROUND

As data center power consumption has increased in recent years, power delivery systems have gradually transitioned from using conventional 12V distribution buses to an emerging industrial standard: the 48V distribution bus. This transition is driven by the advantages provided by higher voltage distribution buses, which include decreased power distribution losses and lower implementation costs.

The Hybrid Switched Capacitor Converter (HSCC) offers high efficiency, a relatively simple structure, and the ability to operate in voltage regulation mode. These capabilities enable effective current sharing in parallel configurations and have made the HSCC increasingly popular as a first-stage converter in 48V power supply systems for data centers.

### SUMMARY

Embodiments of the present disclosure relate to hybrid switched capacitor converters (HSCCs). In at least one embodiment, an integrated coupling device that enables coupling effects between outputs of HSCCs is provided, thereby facilitating improved HSCC operation across different states and duty cycles.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1 is a block diagram illustrating an HSCC device, in accordance with one or more embodiments;

FIG. 2A is a circuit diagram illustrating an HSCC topology, in accordance with one or more embodiments;

FIG. 2B illustrates equivalent circuit diagrams incorporating a coupling effect in accordance with the HSCC topology as depicted in FIG. 2A;

FIG. 3A illustrates the logic of the topological Pulse Width Modulation (PWM) drive signal for the HSCC topology in one power train, in accordance with one or more embodiments;

FIGS. 3B-3E illustrate example control waveforms for different duty cycles (D);

FIGS. 4A-4D provide simulation curves, in accordance with one or more embodiments;

FIG. 5 shows the transient response performance, under different duty cycles, of a traditional HSCC device and an HSCC device in accordance with an embodiment;

FIG. 6 illustrates steady-state performance, under different duty cycles, of a traditional HSCC device and an HSCC device in accordance with an embodiment;

FIGS. 7A and 7B show voltage regulation (VR) efficiency curves of a traditional HSCC device and an HSCC device in accordance with an embodiment;

FIG. 8 shows the steady-state performance, under different duty cycles, of the traditional HSCC device and an HSCC device in accordance with an embodiment HSCC;

FIGS. 9A and 9B show voltage regulation (VR) efficiency curves of a traditional HSCC device and an HSCC device in accordance with an embodiment; and

FIG. 10 shows the transient response performance, under different duty cycles, of a traditional HSCC device and an HSCC device in accordance with an embodiment.

### DETAILED DESCRIPTION

Devices and methods are disclosed herein that relate to hybrid switched capacitor converters (HSCCs), and in particular, to HSCC topologies and tuning methods designed to achieve enhanced performance across different states and various duty cycles.

The present disclosure provides an improved HSCC device that utilizes a coupling device that replaces separate output inductors used in traditional topologies. In traditional configurations, separate output inductors are connected to output terminals of power trains, but these inductors are not coupled. While traditional configurations can reduce current ripple and improve efficiency by increasing output inductance, this increase in inductance also negatively impacts the dynamic response of the converter. In contrast, the coupling device integrates a coupling effect into the output terminals of multiple power trains, which results in different sets of output inductances across various states and duty cycles, allowing tuning of the HSCC device to optimize performance under different operational conditions simultaneously.

In certain embodiments, the coupling device inversely couples the output terminals of two power trains in the improved HSCC device. The coupling device can adopt various configurations, such as utilizing a single coupling inductor, multiple separate coupling inductors, and other variations.

In certain embodiments, the improved HSCC device can achieve enhanced steady-state performance while maintaining the same transient performance as devices that use traditional HSCCs. With enhanced steady-state performance, the improved HSCC device offers higher efficiency, lower loss, and smaller current ripple. As a result, the improved HSCC device can reduce the risk of inductor saturation by using inductors with lower saturation current, which in turn reduces heat dissipation pressure. Additionally, the use of smaller heat sinks not only reduces product costs but also greatly improves product reliability.

In certain embodiments, the improved HSCC device can achieve enhanced transient performance while maintaining the same steady-state performance compared to devices equipped with traditional HSCCs. With enhanced transient performance, the improved HSCC device offers better transient response when the output capacitance is the same. Therefore, the improved HSCC device can further reduce the output capacitance, thereby lowering the overall product cost.

In certain embodiments, the improved HSCC device can enhance both steady-state and transient performance simultaneously.

In certain embodiments, the improved HSCC device provides various other advantages, such as improved power density and reduced cost. For example, in certain embodiments, a single coupling device can be used in the improved HSCC device, in contrast to the separate output inductors in the traditional configurations. This allows the improved HSCC device to reduce the number of output inductors, which potentially reduces the footprint of the overall inductor devices integrated on the printed circuit board (PCB). As a result, the improved HSCC device saves PCB area occupied by output inductors, increases power density, and further reduces PCB costs.

An HSCC circuit is provided, which includes: a first power train comprising a first output terminal, a second power train comprising a second output terminal, and a coupling device. In at least one embodiment, the coupling device includes a first input terminal, a second input terminal, and a third output terminal. In at least one embodiment, the first input terminal of the coupling device is connected to the first output terminal, the second input terminal of the coupling device is connected to the second output terminal. In at least one embodiment, current from the first power train and second power train induces negative coupling in the coupling device.

According to an embodiment of the HSCC circuit, the coupling device is characterized by a first parameter (Lₒ) associated with a self-inductance of the coupling device, a second parameter (Mₒ) associated with a mutual inductance of the coupling device, and a third parameter (kₒ) associated with a coupling coefficient of the coupling device. A value corresponding to the mutual inductance at least approximates a value corresponding to the self-inductance of the coupling device multiplied by the coupling coefficient of the coupling device.

According to an embodiment of the HSCC circuit, at one or more steady-states of a plurality of steady states, the coupling device is associated with a first equivalent inductance (L_{eq1}) and a second equivalent inductance (L_{eq2}) obtained based at least on the first, second, and third parameters. In at least one embodiment, at transient state, the coupling device is associated with a third equivalent inductance (L_{eq3}) and a fourth equivalent inductance (L_{eq4}) obtained based at least on the first, second, and third parameters.

According to an embodiment of the HSCC circuit, the third equivalent inductance (L_{eq3}) and the fourth equivalent inductance (L_{eq4}) are equal to the first parameter (Lₒ) scaled by a factor of one minus the third parameter (kₒ). In at least one embodiment, the third equivalent inductance (L_{eq3}) and the fourth equivalent inductance (L_{eq4}) are less than or equal to a self-inductance (L_{ref}) of a reference inductor.

According to an embodiment of the HSCC circuit, the first equivalent inductance (L_{eq1}) and the second equivalent inductance (L_{eq2}) are associated with a plurality of values at the plurality of steady states. In at least one embodiment, the first equivalent inductance (L_{eq1}) and the second equivalent inductance (L_{eq2}) are greater than or equal to a self-inductance (L_{ref}) of a reference inductor.

According to an embodiment of the HSCC circuit, the first equivalent inductance (L_{eq1}) and the second equivalent inductance (L_{eq2}) are associated with a plurality of values at the plurality of steady states. In at least one embodiment, the third equivalent inductance (L_{eq3}) and the fourth equivalent inductance (L_{eq4}) are equal to the first parameter (Lₒ) scaled by a factor of one minus the third parameter (kₒ). In at least one embodiment, the first equivalent inductance (L_{eq1}), the second equivalent inductance (L_{eq2}), the third equivalent inductance (L_{eq3}), and the fourth equivalent inductance (L_{eq4}) satisfy: a self-inductance (L_{ref}) of a reference inductor is greater than or equal to the third equivalent inductance (L_{eq3}) and the fourth equivalent inductance (L_{eq4}), and the self-inductance (L_{ref}) of the reference inductor is less than or equal to the first equivalent inductance (L_{eq1}) and the second equivalent inductance (L_{eq2}).

According to an embodiment of the HSCC circuit, the first equivalent inductance (L_{eq1}) and the second equivalent inductance (L_{eq2}) are associated with a first set of values of the plurality of values across the plurality of steady states when a duty cycle is greater than or equal to 0.5. In at least one embodiment, the first equivalent inductance (L_{eq1}) and the second equivalent inductance (L_{eq2}) are associated with a second set of values of the plurality of values across the plurality of steady states when the duty cycle is less than 0.5.

According to an embodiment of the HSCC circuit, the third parameter (kₒ) ranges between 0.1 and 0.95.

According to an embodiment of the HSCC circuit, the coupling device comprises a single magnetic core.

According to an embodiment of the HSCC circuit, the coupling device comprises a first magnetic core and a second magnetic core. In at least one embodiment, the first output terminal is connected to the first magnetic core, and the second output terminal is connected to the second magnetic core.

A power converter device is provided, which includes an HSCC circuit according to one or more embodiments of the present disclosure.

A method is provided for designing a hybrid switched capacitor converter (HSCC) device, which includes: providing a first power train comprising a first output terminal, providing a second power train comprising a second output terminal, and providing a coupling device. In at least one embodiment, the coupling device includes a first input terminal, a second input terminal, and a third output terminal. The method further includes: connecting the first output terminal to the first input terminal of the coupling device, connecting the second output terminal to the second input terminal of the coupling device, and coupling the first power train and the second power train through negative coupling induced in the coupling device due to current flow from the first power train and second power train.

According to an embodiment of the method, the coupling device is characterized by a first parameter (Lₒ) associated with a self-inductance of the coupling device, a second parameter (Mₒ) associated with a mutual inductance of the coupling device, and a third parameter (kₒ) associated with a coupling coefficient of the coupling device, and wherein a value corresponding to the mutual inductance at least approximates a value corresponding to the self-inductance of the coupling device multiplied by the coupling coefficient of the coupling device.

According to an embodiment of the method, the method further includes: determining, at one or more steady-states of a plurality of steady states, for the coupling device, a first equivalent inductance (L_{eq1}) and a second equivalent inductance (L_{eq2}) based at least on the first, second, and third parameters, and determining at transient state, for the coupling device, a third equivalent inductance (L_{eq3}) and a fourth equivalent inductance (L_{eq4}) based at least on the first, second, and third parameters.

According to an embodiment of the method, the third equivalent inductance (L_{eq3}) and the fourth equivalent inductance (L_{eq4}) are equal to the first parameter (Lₒ) scaled by a factor of one minus the third parameter (kₒ). In at least one embodiment, the method further includes: tuning the third equivalent inductance (L_{eq3}) and the fourth equivalent inductance (L_{eq4}) so that the third equivalent inductance (L_{eq3}) and the fourth equivalent inductance (L_{eq4}) are less than or equal to a self-inductance (L_{ref}) of a reference inductor.

According to an embodiment of the method, the method further includes: determining, for the first equivalent inductance (L_{eq1}) and the second equivalent inductance (L_{eq2}), a plurality of values at the plurality of steady states, and tuning the first equivalent inductance (L_{eq1}) and the second equivalent inductance (L_{eq2}) so that the first equivalent inductance (L_{eq1}) and the second equivalent inductance (L_{eq2}) are greater than or equal to a self-inductance (L_{ref}) of a reference inductor.

According to an embodiment of the method, the method further includes: determining, for the first equivalent inductance (L_{eq1}) and the second equivalent inductance (L_{eq2}), a plurality of values at the plurality of steady states, and tuning the first equivalent inductance (L_{eq1}), the second equivalent inductance (L_{eq2}), the third equivalent inductance (L_{eq3}), and the fourth equivalent inductance (L_{eq4}) to satisfy: a self-inductance (L_{ref}) of a reference inductor is greater than or equal to the third equivalent inductance (L_{eq3}) and the fourth equivalent inductance (L_{eq4}), and the self-inductance (L_{ref}) of the reference inductor is less than or equal to the first equivalent inductance (L_{eq1}) and the second equivalent inductance (L_{eq2}).

According to an embodiment of the method, determining, for the first equivalent inductance (L_{eq1}) and the second equivalent inductance (L_{eq2}), the plurality of values at the plurality of steady states further includes: determining, for the first equivalent inductance (L_{eq1}) and the second equivalent inductance (L_{eq2}), a first set of values of the plurality of values across the plurality of steady states when a duty cycle is greater than or equal to 0.5, and determining, for the first equivalent inductance (L_{eq1}) and the second equivalent inductance (L_{eq2}), a second set of values of the plurality of values across the plurality of steady states when the duty cycle is less than 0.5.

According to an embodiment of the method, the third parameter (kₒ) ranges between 0.1 and 0.95.

According to an embodiment of the method, the coupling device comprises a single magnetic core.

According to an embodiment of the method, the coupling device comprises a first magnetic core and a second magnetic core. In at least one embodiment, the first output terminal is connected to the first magnetic core, and the second output terminal is connected to the second magnetic core.

More illustrative information will now be set forth regarding various embodiments. It should be strongly noted that the following information is set forth for illustrative purposes and should not be construed as limiting in any manner. Any of the following features may be optionally incorporated with or without the exclusion of other features described.

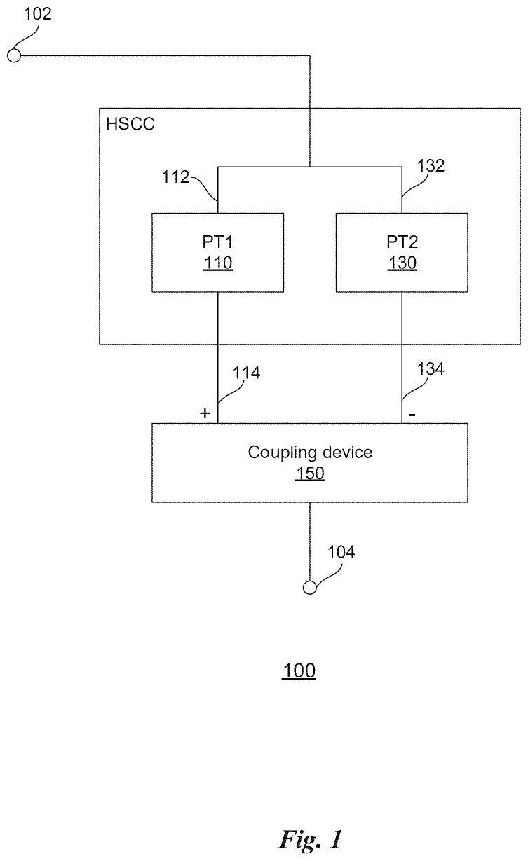

FIG. 1 is a block diagram illustrating an HSCC device 100, in accordance with one or more embodiments. The HSCC device 100 includes a first power train (PT1) 110 and a second power train (PT2) 140. In certain embodiments, the first power train 110 is referred to as the primary power train, while the second power train 130 is referred to as the secondary power train. The first and second power trains are connected in parallel between the source 102 and the load 104. Specifically, the first power train 110 includes an input terminal 112, which is connected to the source 102, and an output terminal 114, is connected to the load 104 through a coupling device 150. Similarly, the second power train 130 includes an input terminal 132, which is connected to the source 102, and an output terminal 134, which is connected to the load 104 through the coupling device 150. In certain embodiments, the output terminal of a power train is referred to as the output winding.

The coupling device 150 has two opposite ends with opposite polarizations. For example, when currents flow into (or out of) both ends of the coupling device 150 simultaneously, the resulting electromagnetic fields interact. If the currents are opposite (meaning both flow into or out of the opposite ends of the coupling device 150), the coupling device 150 induces opposing magnetic fields, leading to destructive interference and reduced net inductance. This effect is referred to as negative mutual inductance or negative coupling, where the mutual inductance between the conductors reduces the overall inductance rather than reinforcing it. When the currents are equal and opposite, the induced magnetic fields will strongly cancel each other, leading to a significant reduction in mutual inductance. When the currents are not equal but still opposite, partial cancellation occurs, and the mutual inductance is reduced. When the currents are not fully opposite (e.g., phase-shifted rather than strictly opposite directions), the cancellation effect will be weaker, and some level of mutual inductance may still exist. If the currents flow in the same direction, the fields reinforce each other, resulting in increased overall inductance, which is referred to as positive coupling.

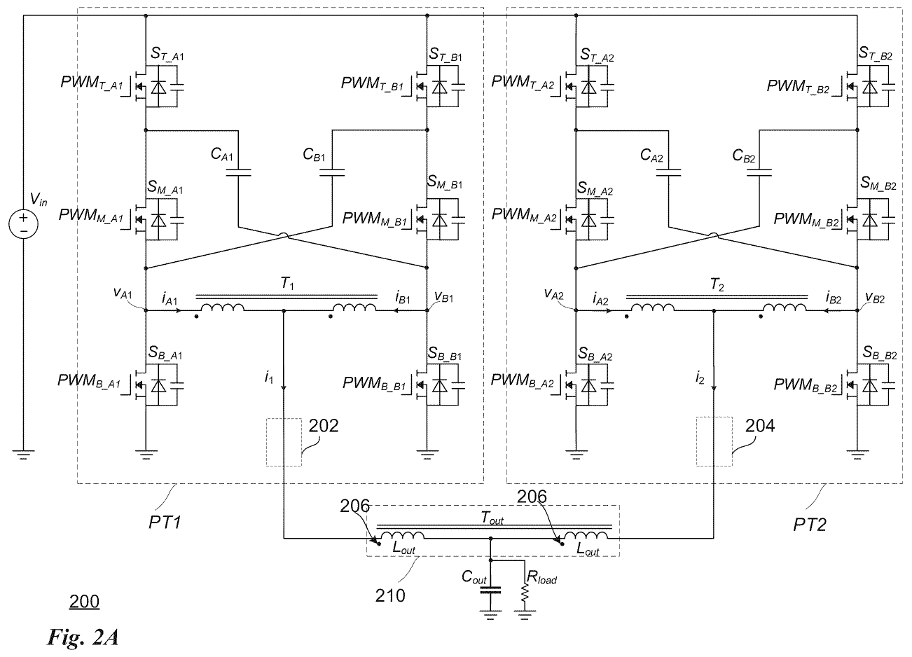

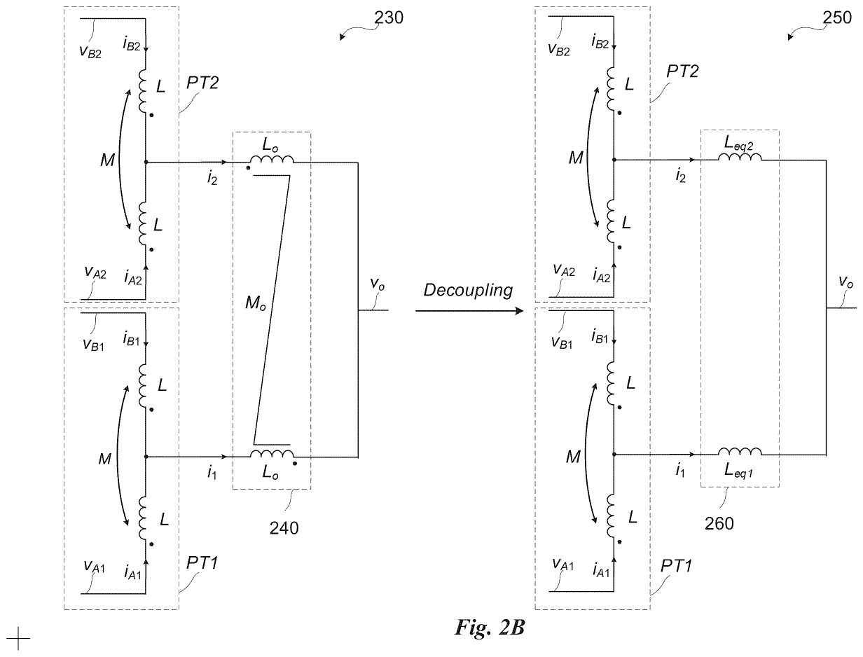

The coupling device 100 can be implemented using various designs, including a single coupling inductor as shown in FIG. 2, two separate inductors coupled through suitable layout arrangements, or other designs. For example, in a configuration with two separate inductors, each inductor may have a self-inductance (Lₒᵤₜ), and the two inductors may exhibit a mutual inductance (Mₒᵤₜ) with a coupling coefficient (k). In certain embodiments, the coupling coefficient k (or kₒ in certain embodiments) ranges from 0.1 to 0.95.

In certain embodiments, the coupling device 100 integrates one or more magnetic cores. When using multiple magnetic cores, the output terminals (e.g., windings) of both power trains of the HSCC device 100 can be connected to separate magnetic cores. In certain embodiments, the coupling device 100 (such as the magnetic core thereof) includes ferrite material.

FIG. 2A is a circuit diagram illustrating an HSCC topology 200, in accordance with one or more embodiments. It should be understood that this and other arrangements described herein are set forth only as examples. Other arrangements and elements (e.g., electrical components, connections, etc.) may be used in addition to or instead of those shown, and some elements may be omitted altogether. Further, many of the elements described herein are functional entities that may be implemented as discrete or distributed components or in conjunction with other components, and in any suitable combination and location. In certain embodiments, the HSCC topology 200 is an example topology for use in one or more embodiments of the HSCC device 100 as illustrated in FIG. 1. Alternatively and/or additionally, the HSCC topology 200 can be implemented in an HSCC circuit that may serve power conversion functions as part of a larger circuit and/or be assembled as a separate circuit or a discrete device.

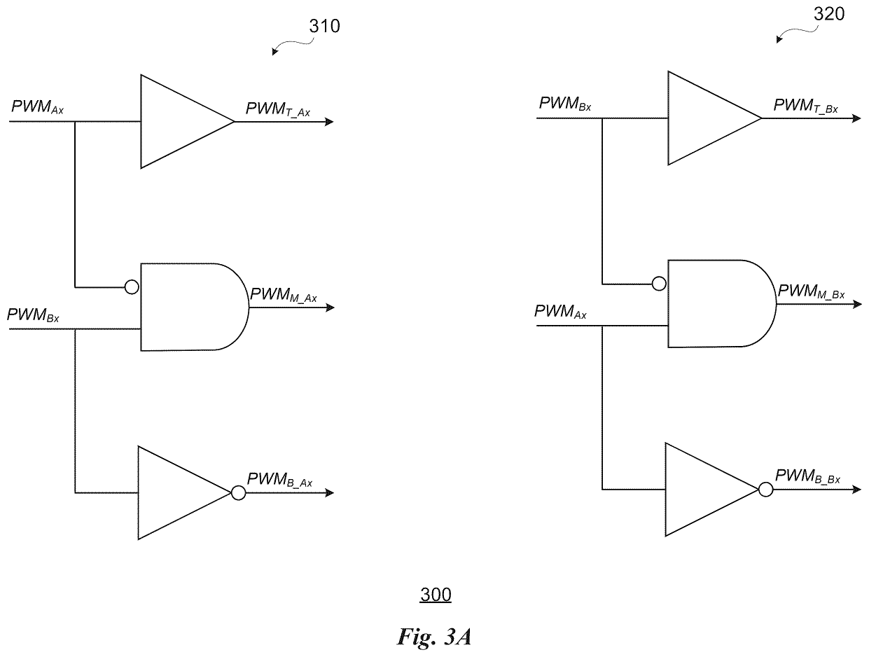

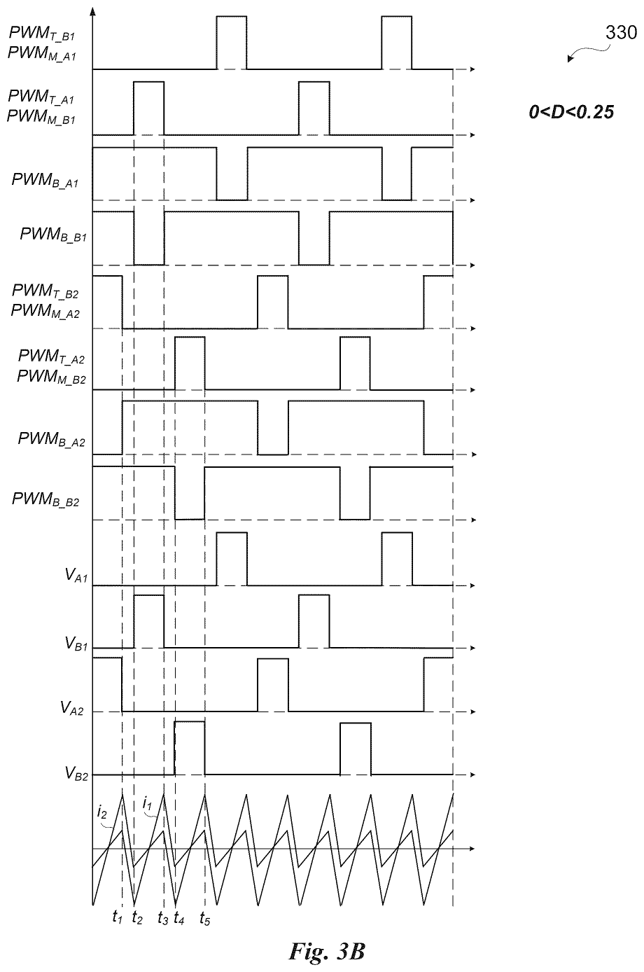

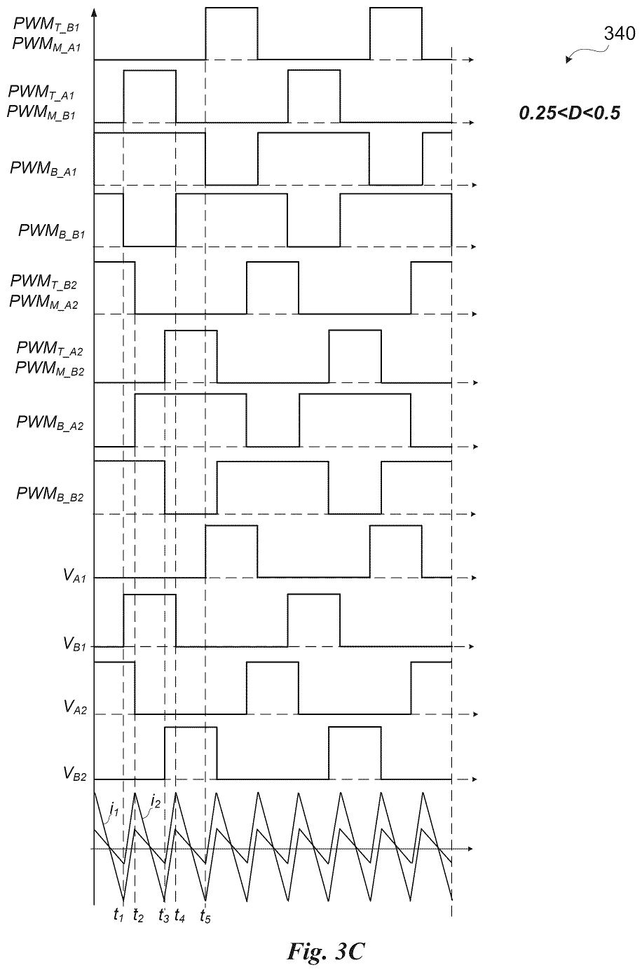

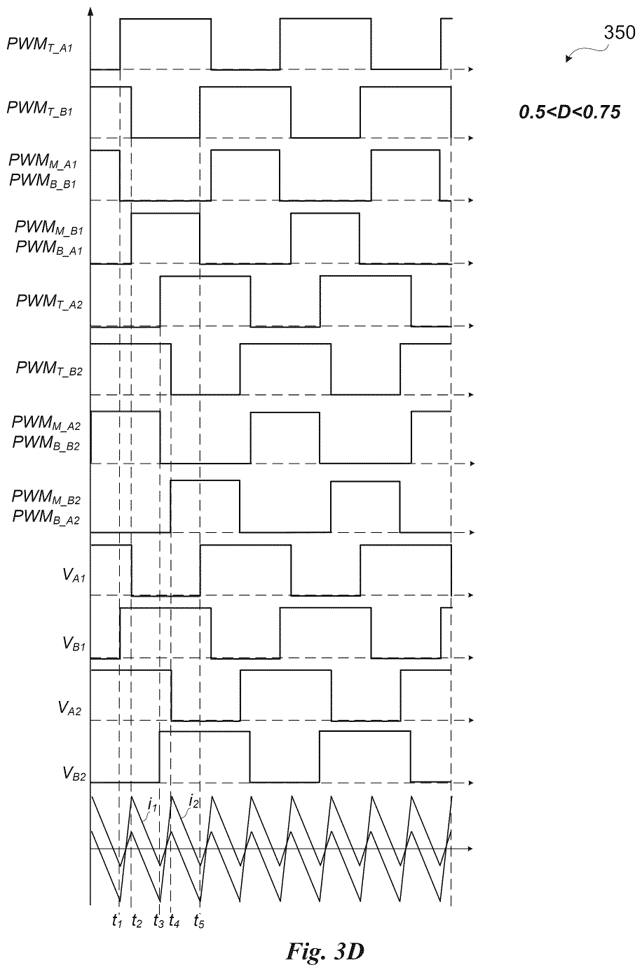

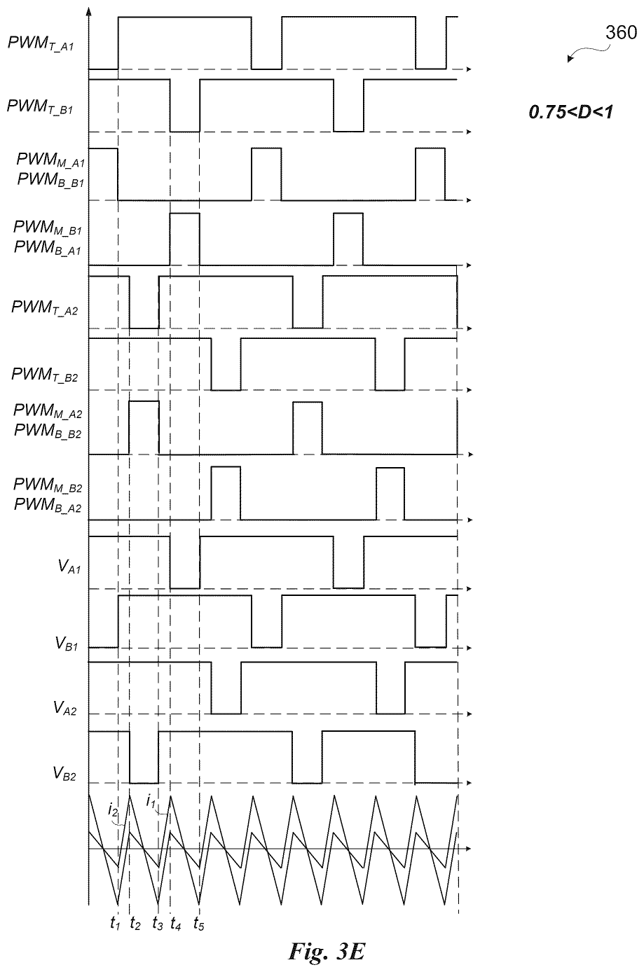

As shown in FIG. 2A, the HSCC topology 200 includes two power trains with a symmetric design, where each power train has a mirrored internal layout of electrical components. For example, the switches (denoted as S) arranged in each power train are symmetrically laid out. In each power train, two phases are defined to control the operation of the power train. In certain embodiments, the left vertical path, which includes a top switch (S_{T}), a middle switch (S_{M}), and a bottom switch (S_{B}) connected sequentially, is controlled by a set of phase A control signals for the corresponding power train, while the mirrored right vertical path is controlled by a set of phase B control signals (e.g., as discussed with reference to FIG. 3A below).

The components in FIG. 2A are annotated as:
v_{A1}: the phase A switch node voltage of PT1
v_{B1}: the phase B switch node voltage of PT1
T₁: the auto-transformer (AT) in PT1
i_{A1}: the AT winding current of PT1 phase A
i_{B1}: the AT winding current of PT1 phase B
i₁: the output current of PT1
v_{A2}: the phase A switch node voltage of PT2
v_{B2}: the phase B switch node voltage of PT2
T₂: the AT in PT2
i_{A2}: the AT winding current of PT2 phase A
i_{B2}: the AT winding current of PT2 phase B
i₂: the output current of PT2
C_{A1}, C_{A2}, C_{B1}, C_{B2}, Cₒᵤₜ: capacitors
Vᵢₙ: input (or source) voltage
R_{load}: load resistance
S_{T}, S_{M}, S_{B}: top, middle, and bottom switches, respectively
PWMs: Pulse Width Modulation (PWM) drive signals
L: the primary and secondary sides of the AT
M: the AT mutual inductance
k: the coupling coefficient of the AT, M=L×k
Tₒᵤₜ: the coupling inductor
Lₒ or Lₒᵤₜ: the primary and secondary sides of the output coupling inductor self-inductance
Mₒ or Mₒᵤₜ: the output coupling inductor mutual inductance
kₒ or kₒᵤₜ: the coupling coefficient of the output coupling inductor, in at least one embodiment, Mₒ=Lₒ×kₒ

In conventional HSCC topologies, each of the primary and secondary power trains may be connected to an output inductor at a respective output path (indicated by dashed boxes 202 and 204, respectively, in FIG. 2A). In this conventional configuration, the two output inductors 202 and 204 are not coupled. The output inductors integrated in the traditional HSCC topology are used to reduce current ripple and enhance efficiency, for example, when the HSCC device/circuit operates in voltage regulation mode. The HSCC device/circuit regulates the voltage by controlling the duty cycle (D) of the Pulse Width Modulation (PWM) drive signal. When the duty cycle is 0.5, the converter step-down ratio is 4:1, the output inductor current ripple is minimal, and the converter has a high efficiency. However, when the duty cycle deviates from 0.5, whether it is greater than 0.5 or less than 0.5, the current ripple of the output inductor increases sharply with the increase of the difference between duty cycle and 0.5, resulting in the decrease of the converter efficiency. Although the current ripple can be reduced by increasing the output inductance value, the increase of the inductance value will also make the dynamic response of the converter worse.

The present disclosure utilizes a coupling device 100 that can be engineered through tunable parameters to achieve enhanced steady-state or dynamic performance without degrading the other. In certain embodiments, the coupling device 100 can be tuned to improve both steady-state and dynamic performance. FIG. 2A illustrates an example of the coupling device 100, which integrates a single coupling inductor 210. However, it should be noted that other configurations and/or arrangements can be implemented as the coupling device 100.

As shown in FIG. 2A, the HSCC topology 200 utilizes the single coupling inductor 210 to replace the two separate output inductors 202 and 204. The coupling inductor 210 includes two arms, each connected to the power trains, through which currents can flow to or from the power trains. The output of the coupling inductor 210 is located between the two arms. The coupling inductor 210 is characterized by a set of parameters, including the self-inductance (denoted as Lₒᵤₜ or Lₒ) corresponding to each arm of the coupling inductor 210, the mutual inductance (denoted as Mₒᵤₜ or Mₒ), and the coupling coefficient (denoted as kₒ or k). The polarization of the coupling inductor 210 (or either arm thereof) is indicated by a dot 206 labeled next to the inductor symbol in the figure. In at least one embodiment a value corresponding to the mutual inductance (Mₒ) at least approximates a value corresponding to the self-inductance (Lₒ) of the coupling device multiplied by the coupling coefficient (kₒ) of the coupling device. In at least one embodiment, Mₒ=Lₒ×kₒ.

The coupling inductor 210 can be equated to a pair of decoupled inductors with self-inductance L_{eq1} and L_{eq2}. Due to the induced coupling effect between both arms of the coupling inductor 210, the equivalent self-inductance L_{eq1} and L_{eq2} can vary during operation.

FIG. 2B illustrates equivalent circuit diagrams incorporating the coupling effect, in accordance with the HSCC topology 200 as depicted in FIG. 2A. As shown in FIG. 2B, circuit diagrams 230 and 250 are used to illustrate the equivalent effect, which models the coupling inductor 210 with two equivalent inductors without mutual coupling. The derivation of the equivalent self-inductance L_{eq1} and L_{eq2} is related to the operation status of the circuit. In circuit diagram 230, the coupling effect of the actual coupling inductor 210 is indicated within the dashed box 240. In circuit diagram 250, the equivalent inductors without mutual coupling are represented within the dashed box 260.

FIG. 3A illustrates the logic of the topological Pulse Width Modulation (PWM) drive signal for the HSCC topology 200 in one power train, in accordance with one or more embodiments. For example, diagram 310 shows the generation of control signals PWM_{T_Ax}, PWM_{M_Ax}, and PWM_{B_Ax} for the primary side (e.g., the left side) in the power train, while diagram 320 shows the generation of control signals PWM_{T_BX}, PWM_{M_BX}, and PWM_{B_BX} for the secondary side (e.g., the right side) in the power train. The output voltage in the power train is adjusted by changing the duty cycle of PWM_{A} and PWM_{B}. In certain embodiments, the phase of PWM_{AX} and PWM_{BX} within the same power train differs by 180°, and the PWM signals of the two coupled power trains are interlaced at 90°. However, it should be noted that other control logic can be applied to control the operation of HSCC devices incorporating the coupling device 100.

FIGS. 3B, 3C, 3D, and 3E show example control waveforms for different duty cycles (D). The waveforms include waveforms for control signals (e.g., the PWM signals), node voltages (e.g., V_{A1} and V_{B1} in PT1 and V_{A2} and V_{B2} in PT2), and output currents (i₁ and i₂ from PT1 and PT2, respectively).

Node voltages are derived from the input voltage based on the on-off status of the corresponding switches (S), which are controlled by the PWM signals. According to the operating waveforms in FIGS. 3B, 3C, 3D, and 3E, steady states correspond to the time periods during which each control signal remains constant, while transient states correspond to the time points at which at least some of the control signals switch between on and off states.

The inductance of equivalent inductors in an HSCC device according to an embodiment is derived hereafter. In this example, the HSCC device implements the HSCC topology 200, as illustrated in FIG. 2A, and operates under the control logic and waveforms shown in FIGS. 3A, 3B, 3C, 3D, and 3E. However, it should be noted that the analysis of this device is only an example; the same principles can be applied to analyze other HSCC devices/circuits with any suitable circuit parameters and/or arrangements.

At a steady state, the voltage drop across the AT in the PT1 is computed as:

$$( L + M ) \frac{d {i}_{B 1}}{d t} - ( L + M ) \frac{d {i}_{A 1}}{d t} = {v}_{B 1} - {v}_{A 1} . \qquad ( Eq . 1 )$$

The voltage drop across one side of the AT (e.g., corresponding to v_{A1}—the phase A switch node voltage of PT1) in PT1 is computed as:

$${L}_{o} \frac{d {i}_{1}}{d t} + L \frac{d {i}_{A 1}}{d t} - M \frac{d {i}_{B 1}}{d t} - {M}_{o} \frac{d {i}_{2}}{d t} = {v}_{A 1} - {V}_{o} . \qquad ( Eq . 2 )$$

The current that passes through one side of the coupling inductor is computed as:

$${i}_{A 1} + {i}_{B 1} = {i}_{1} . \qquad ( Eq . 3 )$$

Similar equations can be obtained for PT2 as:

$$( L + M ) \frac{d {i}_{B 2}}{d t} - ( L + M ) \frac{d {i}_{A 2}}{d t} = {v}_{B 2} - {v}_{A 2} . \qquad ( Eq . 4 )$$

$${L}_{o} \frac{d {i}_{2}}{d t} + L \frac{d {i}_{A 2}}{d t} - M \frac{d {i}_{B 2}}{d t} - {M}_{o} \frac{d {i}_{1}}{d t} = {v}_{A 2} - {V}_{o} . \qquad ( Eq . 5 )$$

$${i}_{A 2} + {i}_{B 2} = {i}_{2} . \qquad ( Eq . 6 )$$

From Equations 1-6, the following equations can be derived:

$$( {L}_{o} + \frac{L - M}{2} ) \frac{d {i}_{1}}{d t} = \frac{{v}_{B 1} + {v}_{A 1}}{2} - {V}_{o} + {M}_{o} \frac{d {i}_{2}}{d t} . \qquad ( Eq . 7 )$$

$$( {L}_{o} + \frac{L - M}{2} ) \frac{d {i}_{2}}{d t} = \frac{{v}_{B 2} + {v}_{A 2}}{2} - {V}_{o} + {M}_{o} \frac{d {i}_{1}}{d t} . \qquad ( Eq . 8 )$$

$$( Eq . 9 )$$

$$[ {( {L}_{o} + \frac{L - M}{2} )}^{2} - {M}_{o}^{2} ] \frac{d {i}_{1}}{d t} = ( {L}_{o} + \frac{L - M}{2} ) ( \frac{{v}_{B 1} + {v}_{A 1}}{2} - {V}_{o} ) + {M}_{o} ( \frac{{v}_{B 2} + {v}_{A 2}}{2} - {V}_{o} ) .$$

$$( Eq . 10 )$$

$$[ {( {L}_{o} + \frac{L - M}{2} )}^{2} - {M}_{o}^{2} ] \frac{d {i}_{2}}{d t} = ( {L}_{o} + \frac{L - M}{2} ) ( \frac{{v}_{B 2} + {v}_{A 2}}{2} - {V}_{o} ) + {M}_{o} ( \frac{{v}_{B 1} + {v}_{A 1}}{2} - {V}_{o} ) .$$

As shown in Equations 7-10, various parameters can affect the calculation of the equivalent self-inductance L_{eq1} and L_{eq2}. For example, v_{A1}, v_{A2}, v_{B1}, v_{B2} are voltage signals that vary according to the control waveforms (e.g., PWMs) of the HSCC, L and M are constants, Lₒ and Mₒ are tunable parameters, and Mₒ=Lₒ×kₒ.

As shown in FIGS. 3B, 3C, 3D, and 3E, v_{A1}, v_{A2}, v_{B1}, v_{B2} generally vary over time. However, during certain time periods, such as t₁-t₂, t₂-t₃, . . . , all of these voltages remain constant within each respective time period. These time periods are referred to as steady states. The following will derive the equivalent self-inductance L_{eq1} and L_{eq2} for each of the steady states under various duty cycles. L_{eq1} is defines as:

$${L}_{eq 1} \frac{{di}_{1}}{dt} = voltage accross the {L}_{eq 1} ,$$

while L_{eq2} is defined as:

$${L}_{e q 2} \frac{d {i}_{2}}{dt} = voltage accross the {L}_{e q 2} .$$

When the duty cycle satisfies 0.25<D<0.5, for the time period t₁~t₂,

$${V}_{A 1} = {V}_{B 2} = 0 , {V}_{A 2} = {V}_{B 1} = \frac{{V}_{i n}}{2} .$$

Accordingly, Equations 9 and 10 can be computed as:

$$( {L}_{o} + \frac{L - M}{2} - {M}_{o} ) \frac{d {i}_{1}}{d t} = \frac{{v}_{B 1} + {v}_{A 1}}{2} - {V}_{o} . \qquad ( Eq . 11 )$$

$$( {L}_{o} + \frac{L - M}{2} - {M}_{o} ) \frac{d {i}_{2}}{d t} = \frac{{v}_{B 2} + {v}_{A 2}}{2} - {V}_{o} . \qquad ( Eq . 12 )$$

From Equations 11 and 12, L_{eq1} and L_{eq2} at this steady state can be computed as:

$${L}_{e q 1} ( {t}_{1} ∼ {t}_{2} ) = {L}_{e q 2} ( {t}_{1} ∼ {t}_{2} ) = {L}_{o} - {M}_{o} = ( 1 - {k}_{o} ) {L}_{o} . \qquad ( Eq \text{.13} )$$

When 0.25<D<0.5, for the time period t₂~t₃, V_{A1}=V_{A2}=V_{B2}=0,

$${V}_{B 1} = \frac{{V}_{i n}}{2} .$$

Similarly, Equations 9 and 10 can be computed as:

$$\frac{{( {L}_{o} + \frac{L - M}{2} )}^{2} - {M}_{o}^{2}}{{L}_{o} + \frac{L - M}{2} - {M}_{o} \frac{2 D}{1 - 2 D}} \frac{{di}_{1}}{dt} = \frac{{v}_{B 1} + {v}_{A 1}}{2} - {V}_{o} . \qquad ( Eq . 14 )$$

$$\frac{{( {L}_{o} + \frac{L - M}{2} )}^{2} - {M}_{o}^{2}}{{L}_{o} + \frac{L - M}{2} - {M}_{o} \frac{1 - 2 D}{2 D}} \frac{{di}_{2}}{dt} = \frac{{v}_{B 2} + {v}_{A 2}}{2} - {V}_{o} . \qquad ( Eq \text{.15} )$$

From Equations 11 and 12, L_{eq1} and L_{eq2} at this steady state can be computed as:

$${L}_{e q 1} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{{M}^{2} 2 D}{1 - 2 D}} - \frac{L - M}{2} . \qquad ( Eq \text{.16} )$$

$${L}_{e q 2} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} . \qquad ( Eq \text{.17} )$$

D is the duty cycle of the HSCC device:

$$\frac{{V}_{o}}{{V}_{in}} = \frac{D}{2} .$$

When 0.25<D<0.5, for the time period t₃~t₄, V_{A1}=V_{A2}=0,

$${V}_{B 1} = {V}_{B 2} = \frac{{V}_{i n}}{2} .$$

Similar to the time period t₁~t₂, L_{eq1} and L_{eq2} at this steady state can be computed as:

$${L}_{e q 1} ( {t}_{3} ∼ {t}_{4} ) = {L}_{e q 2} ( {t}_{3} ∼ {t}_{4} ) = {L}_{o} - {M}_{o} = ( 1 - {k}_{o} ) {L}_{o} . \qquad ( Eq \text{.18} )$$

When 0.25<D<0.5, for the time period t₄~t₅, V_{A1}=V_{A2}=V_{B1}=0,

$${V}_{B 2} = \frac{{V}_{i n}}{2} .$$

Similar to the time period t₂~t₃, L_{eq1} and L_{eq2} at this steady state can be computed as:

$${L}_{e q 1} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} . \qquad ( Eq \text{.19} )$$

$${L}_{e q 2} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} . \qquad ( Eq \text{.20} )$$

When 0<D<0.25, for the time period t₁~t₂, V_{A1}=V_{B2}=V_{A2}=V_{B1}=0. L_{eq1} and L_{eq2} at this steady state can be computed as:

$${L}_{e q 1} ( {t}_{1} ∼ {t}_{2} ) = {L}_{e q 2} ( {t}_{1} ∼ {t}_{2} ) = {L}_{o} - {M}_{o} = ( 1 - {k}_{o} ) {L}_{o} . \qquad ( Eq \text{.21} )$$

When 0<D<0.25, for the time period t₂~t₃, V_{A1}=V_{A2}=V_{B2}=0,

$${V}_{B 1} = \frac{{V}_{i n}}{2} . {L}_{eq 1}$$

and L_{eq2} at this steady state can be computed as:

$${L}_{e q 1} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} . \qquad ( Eq \text{.22} )$$

$${L}_{e q 2} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} . \qquad ( Eq \text{.23} )$$

When 0<D<0.25, for the time period t₃~t₄, V_{A1}=V_{A2}=V_{B1}=V_{B2}=0. L_{eq1} and L_{eq2} at this steady state can be computed as:

$${V}_{B 2} = \frac{{V}_{i n}}{2} . {L}_{eq 1}$$

When 0<D<0.25, for the time period t₄~t₅, V_{A1}=V_{A2}=V_{B1}=0, V_{B2}=0,

$${L}_{e q 1} ( {t}_{3} ∼ {t}_{4} ) = {L}_{e q 2} ( {t}_{3} ∼ {t}_{4} ) = {L}_{o} - {M}_{o} = ( 1 - {k}_{o} ) {L}_{o} . \qquad ( Eq \text{.24} )$$

and L_{eq2} at this steady state can be computed as:

$${L}_{e q 1} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} . \qquad ( Eq \text{.25} )$$

$${L}_{e q 2} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} . \qquad ( Eq \text{.26} )$$

When the duty cycle 0.5<D<0.75, for the time period t₁~t₂, V_{B2}=0, V_{A1}=

$${V}_{B 1} = {V}_{A 2} = \frac{{V}_{i n}}{2} . {L}_{e q 1}$$

and L_{eq2} at this steady state can be computed as:

$${L}_{e q 1} ( {t}_{1} ∼ {t}_{2} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} . \qquad ( Eq \text{.27} )$$

$${L}_{e q 2} ( {t}_{1} ∼ {t}_{2} ) = \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} . \qquad ( Eq \text{.28} )$$

When the duty cycle 0.5<D<0.75, for the time period t₂~t₃, V_{A1}=V_{B2}=0,

$${V}_{B 1} = {V}_{A 2} = \frac{{V}_{i n}}{2} . {L}_{e q 1}$$

and L_{eq2} at this steady state can be computed as:

$${L}_{e q 1} ( {t}_{2} ∼ {t}_{3} ) = {L}_{e q 2} ( {t}_{2} ∼ {t}_{3} ) = {L}_{o} - {M}_{o} = ( 1 - {k}_{o} ) {L}_{o} . \qquad ( Eq \text{.29} )$$

When the duty cycle 0.5<D<0.75, for the time period t₃~t₄, V_{A1}=0,

$${V}_{B 1} = {V}_{A 2} = {V}_{B 2} = \frac{{V}_{i n}}{2} . {L}_{e q 1}$$

and L_{eq2} at this steady state can be computed as:

$${L}_{e q 1} ( {t}_{3} ∼ {t}_{4} ) = \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} . \qquad ( Eq \text{.30} )$$

$${L}_{e q 2} ( {t}_{3} ∼ {t}_{4} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} . \qquad ( Eq \text{.31} )$$

When the duty cycle 0.5<D<0.75, for the time period t₄~t₅, V_{A1}=V_{A2}=0,

$${V}_{B 2} = {V}_{A 1} = \frac{{V}_{i n}}{2} . {L}_{e q 1}$$

and L_{eq2} at this steady state can be computed as:

$${L}_{e q 1} ( {t}_{4} ∼ {t}_{5} ) = {L}_{e q 2} ( {t}_{4} ∼ {t}_{5} ) = {L}_{o} - {M}_{o} = ( 1 - {k}_{o} ) {L}_{o} . \qquad ( Eq \text{.32} )$$

When the duty cycle 0.75<D<1, for the time period t₁~t₂,

$${V}_{A 1} = {V}_{B 1} = {V}_{A 2} = {V}_{B 2} = \frac{{V}_{i n}}{2} . {L}_{e q 1}$$

and L_{eq2} at this steady state can be computed as:

$${L}_{e q 1} ( {t}_{1} ∼ {t}_{2} ) = {L}_{e q 2} ( {t}_{1} ∼ {t}_{2} ) = {L}_{o} - {M}_{o} = ( 1 - {k}_{o} ) {L}_{o} . \qquad ( Eq \text{.33} )$$

When the duty cycle 0.75<D<1, for the time period t₂~t₃, V_{B2}=0,

$${V}_{A 1} = {V}_{B 1} = {V}_{A 2} = \frac{{V}_{i n}}{2} . {L}_{e q 1}$$

and L_{eq2} at this steady state can be computed as:

$${L}_{e q 1} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} . \qquad ( Eq \text{.34} )$$

$${L}_{e q 2} ( {t}_{2} ∼ {t}_{3} ) = \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} . \qquad ( Eq \text{.35} )$$

When the duty cycle 0.75<D<1, for the time period t₃~t₄,

$${V}_{A 1} = {V}_{B 1} = {V}_{A 2} = {V}_{B 2} = \frac{{V}_{i n}}{2} . {L}_{e q 1}$$

and L_{eq2} at this steady state can be computed as:

$${L}_{e q 1} ( {t}_{3} ∼ {t}_{4} ) = {L}_{e q 2} ( {t}_{3} ∼ {t}_{4} ) = {L}_{o} - {M}_{o} = ( 1 - {k}_{o} ) {L}_{o} . \qquad ( Eq \text{.36} )$$

When the duty cycle 0.75<D<1, for the time period t₄−t₅, V_{A1}=0,

$${V}_{B 2} = {V}_{B 1} = {V}_{A 2} = \frac{{V}_{i n}}{2} .$$

$${L}_{e q 1} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} . \qquad ( Eq . 37 )$$

$${L}_{e q 2} ( {t}_{4} ∼ {t}_{5} ) = \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} . \qquad ( Eq . 38 )$$

Transient states include two situations: (i) when the load current step-down, D, is almost equal to zero, and V_{A1}=V_{A2}=V_{B1}=V_{B2}=0; and (ii) when the load step-up D is almost equal to one, and

$${V}_{A 1} = {V}_{A 2} = {V}_{B 1} = {V}_{B 2} = \frac{{V}_{i n}}{2} .$$

For both cases, L_{eq1} and L_{eq2} at this steady state can be computed as:

$${L}_{e q 1} = {L}_{e q 2} = {L}_{o} - {M}_{o} = ( 1 - {k}_{o} ) {L}_{o} . \qquad ( Eq . 39 )$$

Given the above, the equivalent self-inductance L_{eq1} and L_{eq2} at each state (whether steady or transient) can be tuned through one or more tunable parameters (Lₒ, Mₒ, and kₒ), such as using kₒ and Lₒ.

In certain embodiments, increasing the equivalent self-inductance L_{eq1} and L_{eq2} at the steady states can lead to improved steady-state performance in the HSCC device according to an embodiment. For example, the improved HSCC device will reduce current ripple in the load, such as by lowering the peak-to-peak value of the output current ripple. In certain embodiments, reducing the equivalent self-inductance L_{eq1} and L_{eq2} during transient states can enhance transient performance in the HSCC device according to an embodiment. For example, the improved HSCC device will reduce overshoot voltage, such as by decreasing the peak-to-peak value of the output voltage noise.

In certain embodiments, the equivalent self-inductance L_{eq1} and L_{eq2} of a coupling device integrated into the HSCC device (or the HSCC device 100) can be engineered and/or evaluated in comparison to a traditional HSCC device with two separate output inductors (e.g., shown as dashed boxes in FIG. 2A). The output inductance for each output inductor in the traditional HSCC device is denoted as L_{o_tradition}.

According to an embodiment, when 0<D<0.25, for the PT1 and PT2, the PT1 output current has the peak-to-peak value from t₂ to t₃. Suppose that the designed output inductance of the traditional HSCC device is L_{o_tradition}, the condition for an improved HSCC device to achieve an output peak-to-peak current compared to the traditional HSCC device is as follows:

$$\frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} \geq {L}_{o \_ tradition} . 0 < D < 0.25 \qquad ( Eq . 40 )$$

According to an embodiment, when 0.25<D<0.5, for the PT1 and PT2, the PT1 output current has the peak-to-peak value from t₄ to t₅. Suppose that the designed output inductance of the traditional HSCC device is L_{o_tradition} the condition for an improved HSCC device to achieve an output peak-to-peak current compared to the traditional HSCC device is as follows:

$$\frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} \geq {L}_{o \_ tradition} . 0.25 < D < 0.5 \qquad ( Eq . 41 )$$

According to an embodiment, when 0.5<D<0.75, for the FT1 and PT2, PT1 has the output current has the max value from t₁ to t₂, the condition for an improved HSCC device to achieve an output peak-to-peak current compared to the traditional HSCC device is as follows:

$$\frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} \geq {L}_{o \_ tradition} . 0.5 < D < 0.75 \qquad ( Eq \text{.42} )$$

According to an embodiment, when 0.75<D<1, for the PT1 and PT2, PT1 has the output current has the max value from t₄ to t₅, the condition for an improved HSCC device to achieve an output peak-to-peak current compared to the traditional HSCC device is as follows:

$$\frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} \geq {L}_{o \_ tradition} . 0.75 < D < 1 \qquad ( Eq . 43 )$$

According to an embodiment, the condition for an improved HSCC device to achieve a better transient response compared to the traditional HSCC device is as follows:

$${L}_{e q} \leq {L}_{o \_ tradition} , \qquad ( Eq . 44 )$$

For example, L_{eq1}=L_{eq2}=(1−kₒ)Lₒ≤L_{o_tradition}.

As such, in certain embodiments, to design an HSCC device with improved performance for different duty cycles, the self-inductance value Lₒ and mutual inductance Mₒ of the output coupling inductor can be designed to meet the following conditions:

$$( Eq \text{.45} )$$

$$( 1 - {k}_{o} ) {L}_{o} \leq {L}_{o \_ tradition} \leq \{ \begin{matrix}\frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} , & 0 < D < 0.25 \\ \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} , & 0.25 < D < 0.5 \\ \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} , & 0.5 < D < 0.75 \\ \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} , & 0.75 < D < 1\end{matrix} .$$

According to one or more embodiments, an HSCC device with improved performance at a specific duty cycle can be achieved by tuning the parameters, such as kₒ and Lₒ, to satisfy the corresponding conditions in Equation 45. According to an embodiment, an HSCC device with improved performance for all four duty cycles can be designed as:

$$( Eq . 46 )$$

$$( 1 - {k}_{o} ) {L}_{o} \leq {L}_{o \_ tradition} \leq min \{ \frac{{( {L}_{o} + \frac{L - M}{2} )}^{2} - {M}_{o}^{2}}{{L}_{o} + \frac{L - M}{2} - {M}_{o} \frac{2 D}{1 - 2 D}} - \frac{L - M}{2} , \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} , \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} , \frac{{( {L}_{o} + \frac{L - M}{2} )}^{2} - {M}_{o}^{2}}{{L}_{o} + \frac{L - M}{2} - {M}_{o} \frac{2 - 2 D}{1 - 2 D}} - \frac{L - M}{2} \} .$$

Similarly, in certain embodiments, depending on which duty cycles an HSCC device is intended to be improved, the corresponding peak output current can be specifically reduced by increasing the equivalent inductance during the designated time period for the specific duty cycle(s).

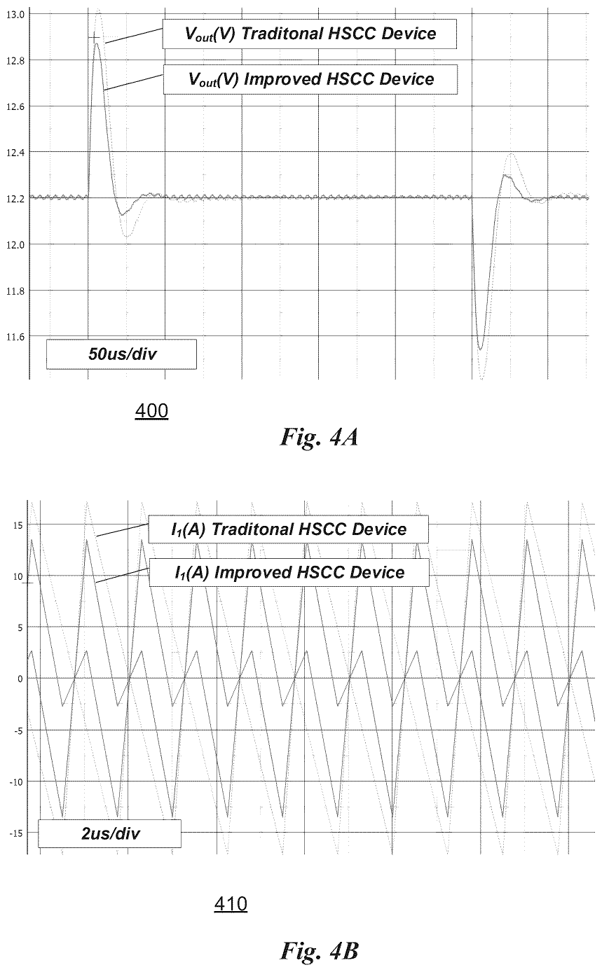

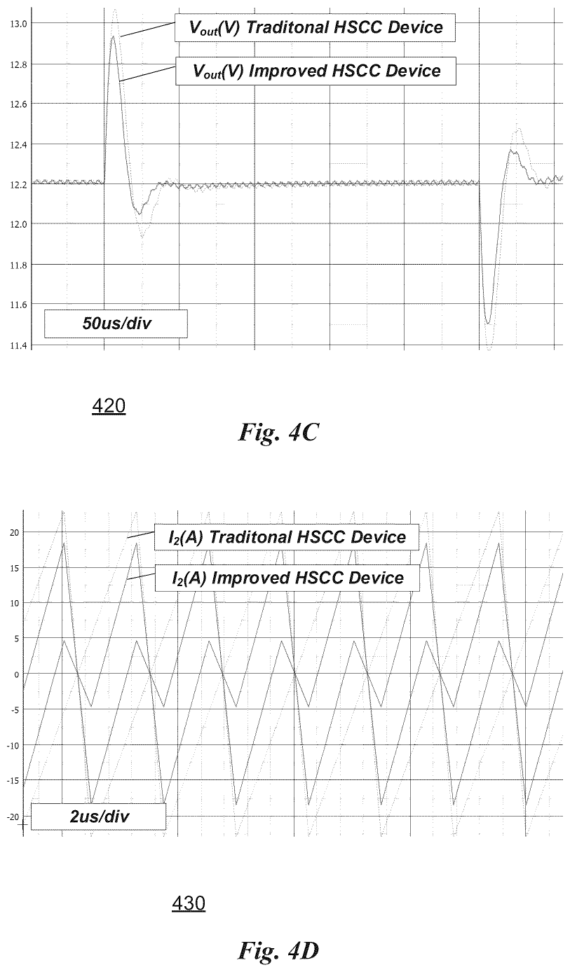

FIGS. 4A-4D provide simulation curves, in accordance with one or more embodiments. The simulation curves validate the steady-state and dynamic performance of an improved HSCC device according to an embodiment and a traditional HSCC device. In this example, the improved HSCC device implements the HSCC topology 200 as shown in FIG. 2A.

In this simulation, the configuration and parameters used for the simulation are as follows: two PTs are arranged in parallel; the auto-transformer's primary and secondary inductance (L) (corresponding to each side of the AT) is 2.2 μH; the mutual inductance (M) of the AT is 2.17 μH; the self-inductance (Lₒ) of the output coupled inductor is 160 nH; the mutual inductance (Mₒ) of the output coupled inductor is 80 nH; the output voltage (Vₒᵤₜ) is 12.1V; for the load current, the low value is OA and the high value is 250 A; the switching frequency is 200 kHz; the minimum input voltage (Vᵢₙ) is 40V at D>0.5, the maximum input voltage (Vᵢₙ) is 60V at D<0.5. Based on these parameters, an output inductance of the traditional HSCC can be determined for comparison in the simulation.

For example, according to the above analysis, when the following condition is satisfied, the improved HSCC device has a lower current ripple and better transient response relative to the traditional HSCC device at 0.25<D<0.75:

$$( Eq . 48 )$$

$$( 1 - {k}_{o} ) {L}_{o} \leq {L}_{o \_ tradition} \leq min \{ \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} , \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} \} .$$

As such, the value range of output inductance of the traditional HSCC device can be determined based on parameters of the improved HSCC device when Vᵢₙ is 40V or 60V:

$$80 nH \leq {L}_{o \_ tradition} \leq min \{ 139.8 nH , 144 nH \} . \qquad ( Eq . 49 )$$

Given the above, an output inductance of 110 nH is used in the traditional HSCC device for comparison in the simulation.

FIGS. 4A and 4B provide simulation curves when 0.5<D<0.75, in accordance with one or more embodiments. Plot 400 illustrates the output voltage (Vₒᵤₜ) during the transient state for both the improved HSCC device according to an embodiment and the traditional HSCC device when the input voltage is 40V. Plot 410 illustrates the output inductor current (I₁) waveform in the steady state for both the improved HSCC device according to an embodiment and the traditional HSCC device when the input voltage is 40V.

For transient state, as shown in FIG. 4A, the improved HSCC device has better transient performance than the traditional HSCC device no matter the load step-up or load step-down. In this example, for the traditional HSCC device, the output voltage peak-to-peak value is 1612 mV, and for the improved HSCC device, the output voltage peak-to-peak value is 1327 mV. As such, the improved HSCC device can improve dynamic performance by 18.14%.

For steady state, as shown in FIG. 4B, the output current ripple of the improved HSCC device is less than the traditional HSCC device with the same circuit parameters. In this example, the peak-to-peak value of the improved HSCC output current ripple is 27.03 A, while that of the traditional HSCC output current ripple is 34.43 A. As such, the improved HSCC device reduces the peak-to-peak value of the output current ripple by 21.5%.

FIGS. 4C and 4D provide simulation curves when 0.25<D<0.5. Plot 400 illustrates the output voltage (Vₒᵤₜ) during the transient state for both the improved HSCC device according to an embodiment and the traditional HSCC device when the input voltage is 60V. Plot 410 illustrates the output inductor current (I₁) waveform in the steady state for both the improved HSCC device according to an embodiment and the traditional HSCC device when the input voltage is 60V.

For transient state, as shown in FIG. 4C, the improved HSCC device has better transient performance than the traditional HSCC device no matter the load step-up or load step-down. In this example, for the traditional HSCC device, the output voltage peak-to-peak value is 1712 mV, and for the improved HSCC device, the output voltage peak-to-peak value is 1435 mV. As such, the improved HSCC device can improve dynamic performance by 16.17%.

For steady state, as shown in FIG. 4D, the output current ripple of the improved HSCC device is less than the traditional HSCC device with the same circuit parameters. In this example, the peak-to-peak value of the improved HSCC output current ripple is 36.9 A, while that of the traditional HSCC output current ripple is 45.7 A. As such, the improved HSCC device reduces the peak-to-peak value of the output current ripple by 19.26%.

Simulation results show that the improved HSCC device according to an embodiment enhances both steady-state and dynamic performance compared to the traditional HSCC device.

Various experiments have been conducted to evaluate the steady-state and transient performance of the improved HSCC device according to an embodiment compared to the traditional HSCC device. For example, the following parameters are used in the experiments: the HSCC device according to an embodiment includes two power trains; the auto-transformer's primary and secondary inductance (L) (corresponding to each side of the AT) is 2.2 μH; the self-inductance (Lₒ) of the output coupled inductor is 160 nH; the mutual inductance (Mₒ) of the output coupled inductor is 80 nH; the output voltage (Vₒᵤₜ) is 12.1V. For transient state, the load current low value is OA, the high value is 220 A, slew rate is 5 A/μs. For steady state: the load full current is 140 A.

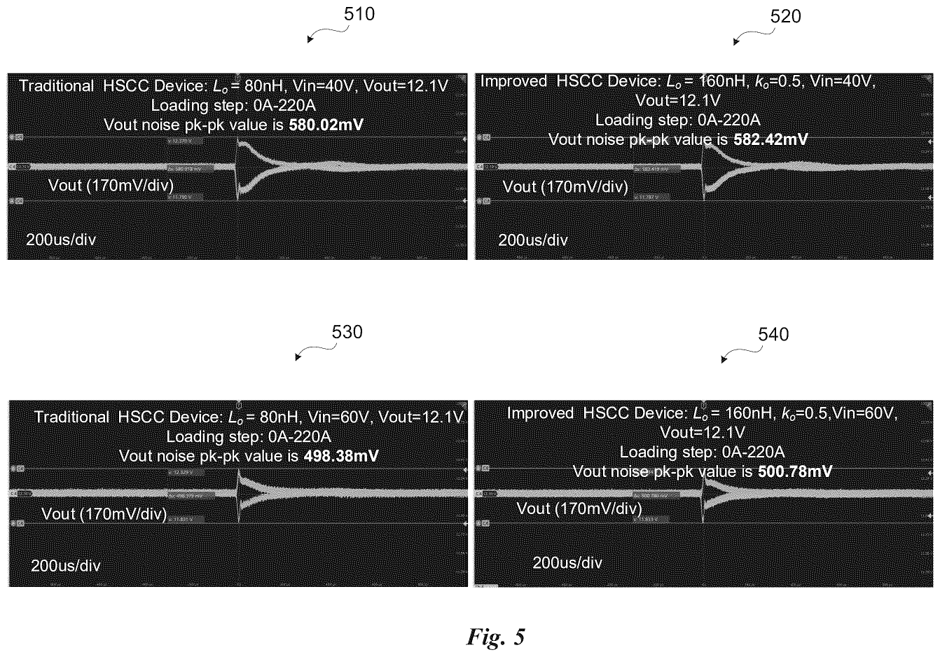

The above analysis shows that, compared to the traditional HSCC device, the improved HSCC device according to an embodiment reduces current ripple, improves efficiency, and enhances transient performance. FIGS. 5-10 show experimental results comparing the improved HSCC device according to an embodiment with the traditional HSCC device when 0.25<D<0.5 or 0.5<D<0.75.

FIGS. 5-7 show experimental results that maintain the same transient response while comparing the steady-state performance. The same transient response is maintained, when:

$$( 1 - {k}_{o} ) {L}_{o} = {L}_{o \_ tradition} . \qquad ( Eq . 50 )$$

In the experiment, the output inductor parameters of the improved HSCC device according to an embodiment are Lₒ=160 nH, kₒ=0.5, and the output inductor of the traditional HSCC device is L_{o_tradition}=80 nH. As such, the condition set forth in Equation 50 is satisfied. The equivalent inductance can be derived when the output current has the maximum value, which is about 140 nH. The equivalent inductance is larger than L_{o_tradition}=80 nH, indicating that the improved HSCC device has a smaller current ripple than the traditional HSCC device.

FIG. 5 shows the transient response performance of the traditional HSCC device (L_{o_tradition}=80 nH) and the improved HSCC device according to an embodiment (Lₒ=160 nH, kₒ=0.5) under different duty cycles (D).

Plots 510 and 520 show results when Vin=40V, D>0.5. For the traditional HSCC device (in plot 510), the output voltage peak to peak value is 580.2 mV, while for the improved HSCC device (in plot 520), the output voltage peak to peak value is 582.42 mV. As such, the transient response performance for the improved HSCC device and the traditional HSCC device are almost the same.

Plots 530 and 540 show results when Vin=60V, D<0.5. For the traditional HSCC device (in plot 530), the output voltage peak-to-peak value is 498.38 mV, while for the improved HSCC device (in plot 540), the output voltage peak-to-peak value is 500.78 mV. As such, the transient response performance for the improved HSCC device and the traditional HSCC device are almost the same.

The above experiments show that the dynamic performance of the traditional HSCC device and the improved HSCC device, according to an embodiment, is consistent under designed parameters, which verifies the correctness of the theoretical analysis.

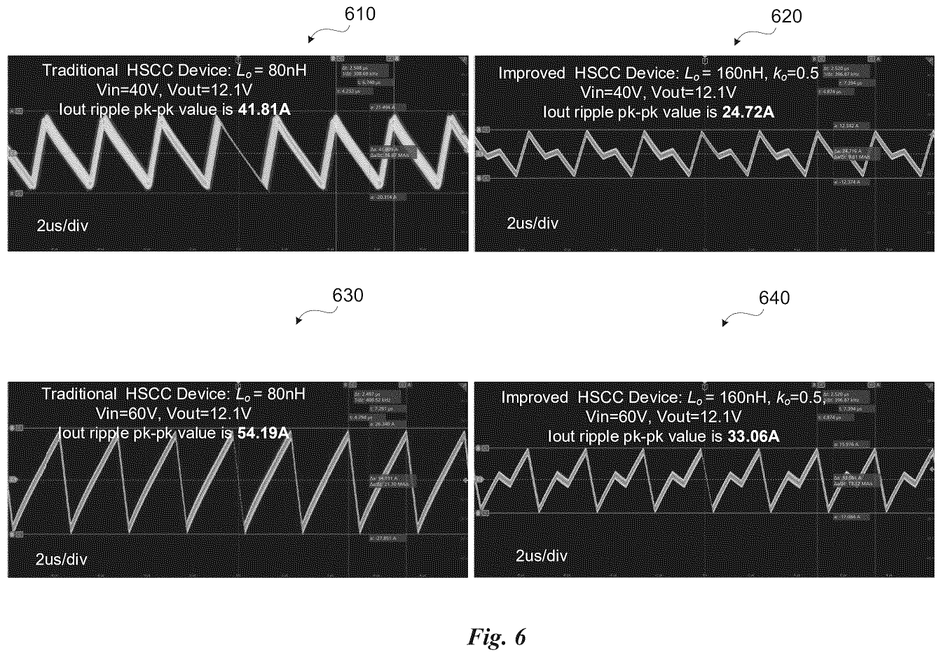

The steady-state performance according to an embodiment is compared and shown in FIG. 6. FIG. 6 shows the output current ripple of the traditional HSCC device (L_{o_tradition}=80 nH) and the improved HSCC device (Lₒ=160 nH, kₒ=0.5) under idle state (or steady state), according to an embodiment.

Plots 610 and 620 show results when Vin=40V, D>0.5. For the traditional HSCC device (in plot 610), the output current ripple is 41.81 A, while for the improved HSCC device (in plot 620), the output current ripple is 24.72 A. As such, compared to the traditional HSCC device, the improved HSCC device can reduce the current ripple by 40.88%.

Plots 630 and 640 show results when Vin=60V, D<0.5. For the traditional HSCC device (in plot 630), the output current ripple is 54.19 A, while for the improved HSCC device (in plot 640), the output current ripple is 33.06 A. As such, compared to the traditional HSCC device, the improved HSCC device can reduce the current ripple by 38.99%.

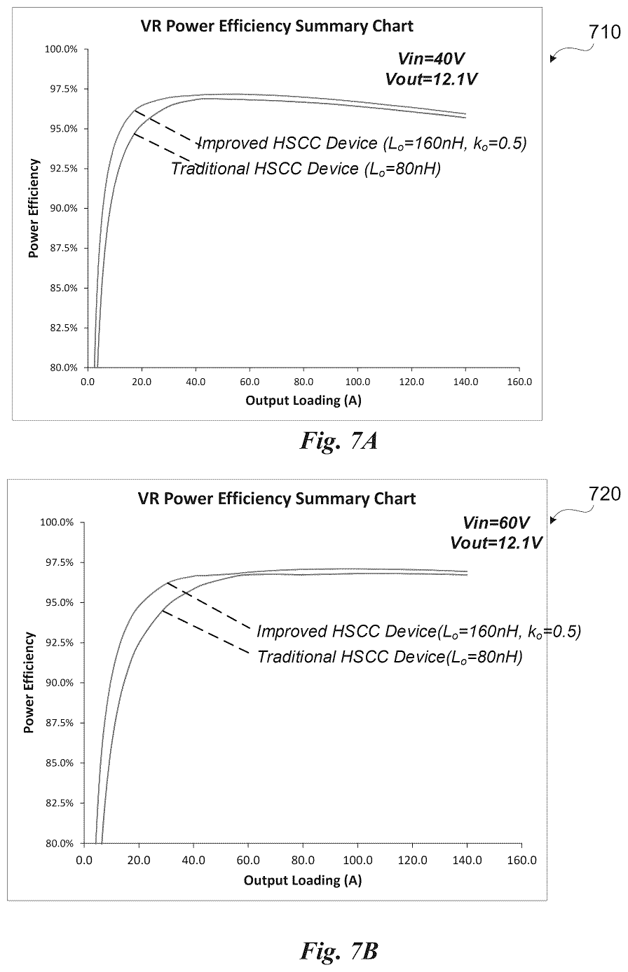

FIGS. 7A and 7B provide voltage regulation (VR) efficiency curves 710 and 720 of the traditional HSCC device (L_{o_tradition}=80 nH) and the improved HSCC device according to an embodiment (Lₒ=160 nH, kₒ=0.5) according to FIG. 6. As shown in FIGS. 7A and 7B, from light load to full load, the efficiency of the improved HSCC device is always higher than that of the traditional HSCC device.

As shown in FIG. 7A, when Vin=40V, D>0.5, in idle condition, the traditional HSCC loss is 11.02 W, and the improved HSCC loss is 7.48 W. As such, compared to the traditional HSCC device, the improved HSCC device reduces idle state (or steady state) loss by 32%, equating to a savings of 3.54 W. For the full loading 140 A, the VR efficiency of the traditional HSCC device is 95.63%, the total loss is 77.67 W. The VR efficiency of the improved HSCC device is 95.94%, the total loss is 71.91 W. As such, compared to the traditional HSCC device, the improved HSCC device increases VR efficiency at full load by 0.31% and reduces total loss by 5.77 W.

As shown in FIG. 7B, when Vin=60V, D<0.5, in idle condition, in idle condition, the traditional HSCC loss is 19.92 W, and the improved HSCC loss is 13.04 W. As such, compared to the traditional HSCC device, the improved HSCC device reduces idle state (or steady state) loss by 34%, equating to a savings of 6.88 W. For the full loading 140 A, the VR efficiency of the traditional HSCC device is 96.68%, the total loss is 58.31 W. The VR efficiency of the improved HSCC is 96.93%, the total loss is 53.76 W. As such, compared to the traditional HSCC device, the improved HSCC device increases VR efficiency at full load by 0.25% and reduces total loss by 4.55 W.

As such, an improved HSCC device according to an embodiment can reduce total power consumption, thereby significantly lowering converter thermal stress and enhancing product stability.

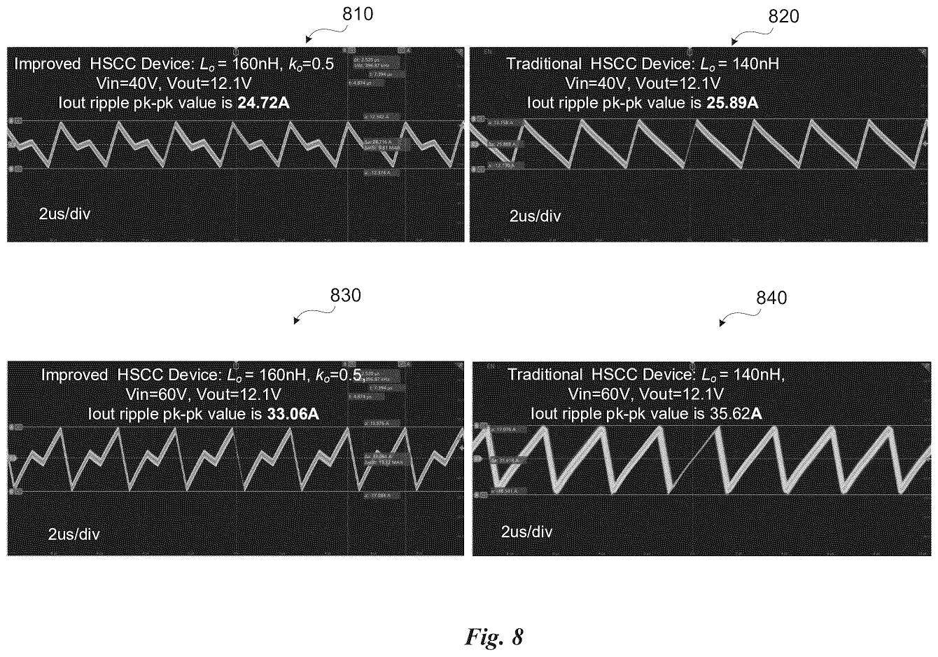

FIGS. 8-10 show experimental results that maintain the same current ripple/efficiency while comparing the transient performance, according to an embodiment. From Equation 48, the same current ripple/efficiency is maintained, when:

$$( Eq . 51 )$$

$${L}_{o \_ tradition} = min \{ \frac{{( {L}_{o} + \frac{L - M}{2} )}^{2} - {M}_{o}^{2}}{{L}_{o} + \frac{L - M}{2} - {M}_{o} \frac{1 - 2 D}{2 D}} - \frac{L - M}{2} , \frac{{( {L}_{o} + \frac{L - M}{2} )}^{2} - {M}_{o}^{2}}{{L}_{o} + \frac{L - M}{2} - {M}_{o} \frac{1 - 2 D}{2 - 2 D}} - \frac{L - M}{2} \} .$$

In the experiment, the output inductor parameters of the improved HSCC device according to an embodiment are Lₒ=160 nH, k=0.5. By substituting the above parameters into Equation 51, the output inductance L_{o_tradition} of the traditional HSCC device can be obtained when the current ripple is the same, as:

$${L}_{o \_ tradition} \leq min \{ 139.8 nH , 144 nH \} . \qquad ( Eq . 52 )$$

Given Equation 52, a 140 nH output inductance is used in the traditional HSCC device for comparison experiments.

FIG. 8 shows the output current ripple of the traditional HSCC device (L_{o_tradition}=140 nH) and the improved HSCC device according to an embodiment (Lₒ=160 nH, kₒ=0.5) under idle state (or steady state).

Plots 810 and 820 show results when Vin=40V, D>0.5. For the traditional HSCC device (in plot 810), the output current ripple is 25.89 A, while for the improved HSCC device (in plot 820), the output current ripple is 24.72 A. As such, compared to the traditional HSCC device, the improved HSCC device has the almost same current ripple.

Plots 830 and 840 show results when Vin=60V, D<0.5. For the traditional HSCC device (in plot 830), the output current ripple is 35.62 A, while for the improved HSCC device (in plot 840), the output current ripple is 33.06 A. As such, compared to the traditional HSCC device, the improved HSCC device has the almost same current ripple.

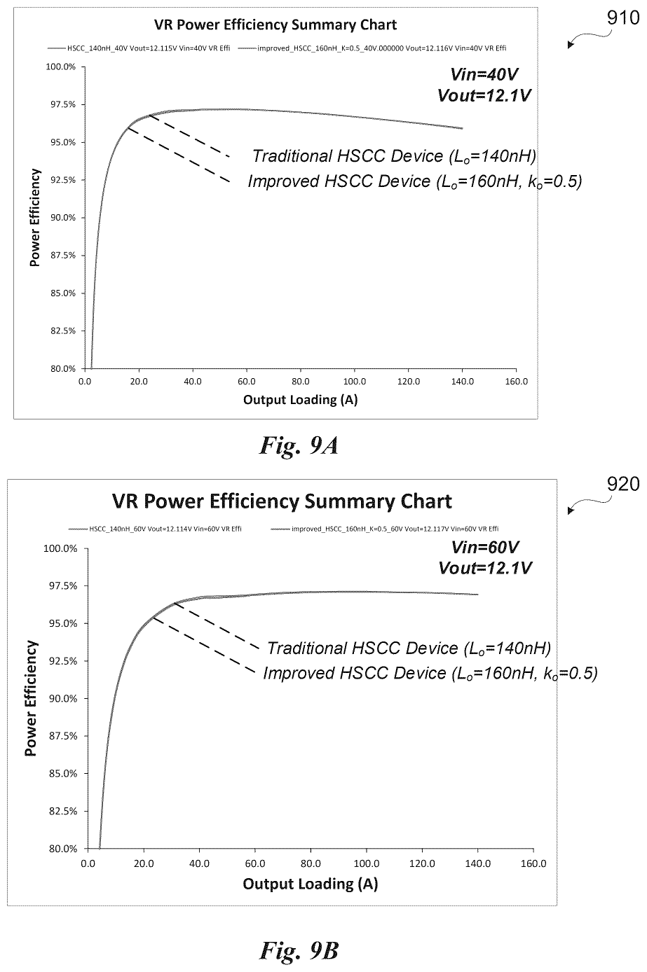

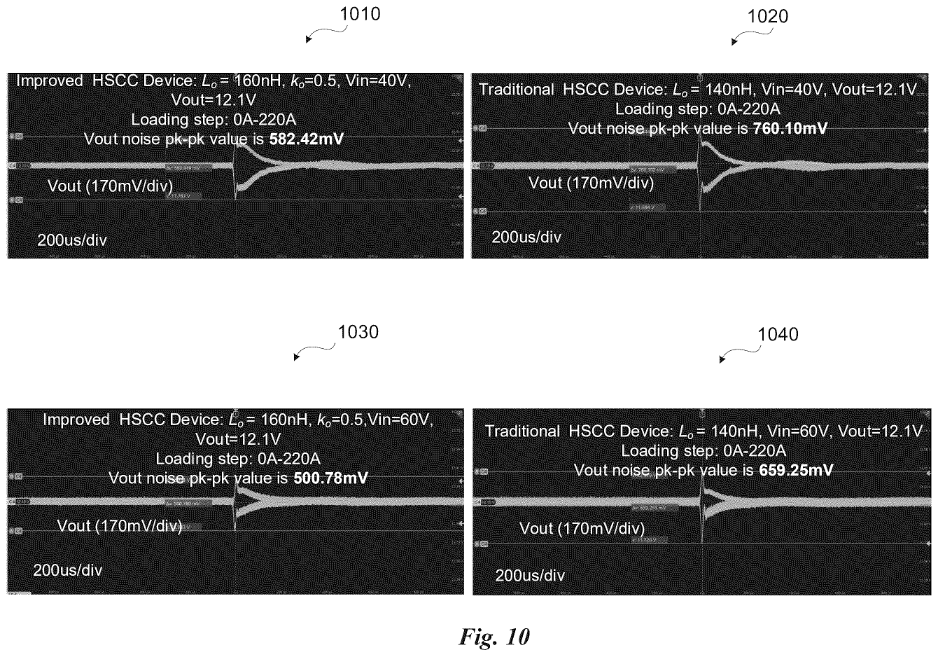

FIGS. 9A and 9B provide voltage regulation (VR) efficiency curves 910 and 920 of the traditional HSCC device (L_{o_tradition}=140 nH) and the improved HSCC device according to an embodiment (Lₒ=160 nH, k₀=0.5) according to FIG. 8. As shown in FIGS. 7A and 7B, from light load to full load, the efficiency of the improved HSCC device and that of the traditional HSCC device nearly coincide, showing substantially the same efficiency.

FIG. 10 shows the transient response performance of the traditional HSCC device (L_{o_tradition}=140 nH) and the improved HSCC device according to an embodiment (Lₒ=160 nH, kₒ=0.5) under different duty cycles (D).

Plots 1010 and 1020 show results when Vin=40V, D>0.5. For the traditional HSCC device (in plot 1010), the output voltage peak to peak value is 760.10 mV, while for the improved HSCC device (in plot 1020), the output voltage peak to peak value is 582.42 mV. As such, compared to the traditional HSCC device, the improved HSCC device reduces transient noise by 23.38%.

Plots 1030 and 1040 show results when Vin=60V, D<0.5. For the traditional HSCC device (in plot 1030), the output voltage peak-to-peak value is 659.25 mV, while for the improved HSCC device (in plot 1040), the output voltage peak-to-peak value is 500.78 mV. As such, compared to the traditional HSCC device, the improved HSCC device reduces transient noise by 24.04%.

As such, when L_{o_tradition}=80 nH, Lₒ=160 nH, kₒ=0.5, the improved HSCC device according to an embodiment exhibits similar transient performance to the traditional HSCC device. However, the improved HSCC device demonstrates higher efficiency, lower loss, and smaller current ripple. In other words, the improved HSCC device can reduce the risk of inductance saturation by using inductors with lower saturation current. This reduction in heat dissipation pressure allows for the use of smaller heat sinks, which not only lowers product costs but also significantly enhances product reliability.

When L_{o_tradition}=140 nH, Lₒ=160 nH, kₒ=0.5, the improved HSCC device according to an embodiment and the traditional HSCC device exhibit similar current ripple and efficiency. However, with the same output capacitance, the improved HSCC device demonstrates better transient performance. In other words, the improved HSCC device can further reduce the output capacitance, leading to additional cost savings for the product.

When 80 nH<L_{o_tradition}<140 nH, Lₒ=160 nH, kₒ=0.5, the improved HSCC device according to an embodiment can not only enhance dynamic performance but also reduce the current ripple, thereby increasing efficiency. In other words, the improved HSCC device offers advantages in both steady-state and dynamic performance.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A hybrid-switched capacitor converter (HSCC) circuit, comprising:
a first power train comprising a first output terminal;
a second power train comprising a second output terminal; and
a coupling device comprising a first input terminal, a second input terminal, and a third output terminal,
wherein the first input terminal of the coupling device is connected to the first output terminal, the second input terminal of the coupling device is connected to the second output terminal, and
wherein current from the first power train and second power train induces negative coupling in the coupling device.

2. The HSCC circuit of claim 1, wherein the coupling device is characterized by a first parameter (Lₒ) associated with a self-inductance of the coupling device, a second parameter (Mₒ) associated with a mutual inductance of the coupling device, and a third parameter (kₒ) associated with a coupling coefficient of the coupling device, and wherein a value corresponding to the mutual inductance at least approximates a value corresponding to the self-inductance of the coupling device multiplied by the coupling coefficient of the coupling device.

3. The HSCC circuit of claim 2, wherein at one or more steady-states of a plurality of steady states, the coupling device is associated with a first equivalent inductance (L_{eq1}) and a second equivalent inductance (L_{eq2}) obtained based at least on the first, second, and third parameters,
wherein at a transient state, the coupling device is associated with a third equivalent inductance (L_{eq3}) and a fourth equivalent inductance (L_{eq4}) obtained based at least on the first, second, and third parameters.

4. The HSCC circuit of claim 3, wherein the third equivalent inductance (L_{eq3}) and the fourth equivalent inductance (L_{eq4}) are equal to the first parameter (Lₒ) scaled by a factor of one minus the third parameter (kₒ),
wherein the third equivalent inductance (L_{eq3}) and the fourth equivalent inductance (L_{eq4}) are less than or equal to a self-inductance (L_{ref}) of a reference inductor.

5. The HSCC circuit of claim 3, wherein the first equivalent inductance (L_{eq1}) and the second equivalent inductance (L_{eq2}) are associated with a plurality of values at the plurality of steady states,
wherein the first equivalent inductance (L_{eq1}) and the second equivalent inductance (L_{eq2}) are greater than or equal to a self-inductance (L_{ref}) of a reference inductor.

6. The HSCC circuit of claim 3, wherein the first equivalent inductance (L_{eq1}) and the second equivalent inductance (L_{eq2}) are associated with a plurality of values at the plurality of steady states,
wherein the third equivalent inductance (L_{eq3}) and the fourth equivalent inductance (L_{eq4}) are equal to the first parameter (Lₒ) scaled by a factor of one minus the third parameter (kₒ),
wherein the first equivalent inductance (L_{eq1}), the second equivalent inductance (L_{eq2}), the third equivalent inductance (L_{eq3}), and the fourth equivalent inductance (L_{eq4}) satisfy:
a self-inductance (L_{ref}) of a reference inductor is greater than or equal to the third equivalent inductance (L_{eq3}) and the fourth equivalent inductance (L_{eq4}); and
the self-inductance (L_{ref}) of the reference inductor is less than or equal to the first equivalent inductance (L_{eq1}) and the second equivalent inductance (L_{eq2}).

7. The HSCC circuit of claim 5, wherein the first equivalent inductance (L_{eq1}) and the second equivalent inductance (L_{eq2}) are associated with a first set of values of the plurality of values across the plurality of steady states when a duty cycle is greater than or equal to 0.5,
wherein the first equivalent inductance (L_{eq1}) and the second equivalent inductance (L_{eq2}) are associated with a second set of values of the plurality of values across the plurality of steady states when the duty cycle is less than 0.5.

8. The HSCC circuit of claim 2, wherein the third parameter (kₒ) ranges between 0.1 and 0.95.

9. The HSCC circuit of claim 1, wherein the coupling device comprises a single magnetic core.

10. The HSCC circuit of claim 1, wherein the coupling device comprises a first magnetic core and a second magnetic core,
wherein the first output terminal is connected to the first magnetic core, and the second output terminal is connected to the second magnetic core.

11. A power converter device comprising the HSCC circuit of claim 1.

12. A method for designing a hybrid switched capacitor converter (HSCC) device, comprising:
providing a first power train comprising a first output terminal;
providing a second power train comprising a second output terminal;
providing a coupling device comprising a first input terminal, a second input terminal, and a third output terminal;
connecting the first output terminal to the first input terminal of the coupling device;
connecting the second output terminal to the second input terminal of the coupling device; and
coupling the first power train and the second power train through negative coupling induced in the coupling device due to current flow from the first power train and second power train.

13. The method of claim 12, wherein the coupling device is characterized by a first parameter (Lₒ) associated with a self-inductance of the coupling device, a second parameter (Mₒ) associated with a mutual inductance of the coupling device, and a third parameter (kₒ) associated with a coupling coefficient of the coupling device, and wherein a value corresponding to the mutual inductance at least approximates a value corresponding to the self-inductance of the coupling device multiplied by the coupling coefficient of the coupling device.

14. The method of claim 13, further comprising:
determining, at one or more steady-states of a plurality of steady states, for the coupling device, a first equivalent inductance (L_{eq1}) and a second equivalent inductance (L_{eq2}) based at least on the first, second, and third parameters; and
determining at transient state, for the coupling device, a third equivalent inductance (L_{eq3}) and a fourth equivalent inductance (L_{eq4}) based at least on the first, second, and third parameters.

15. The method of claim 14, wherein the third equivalent inductance (L_{eq3}) and the fourth equivalent inductance (L_{eq4}) are equal to the first parameter (Lₒ) scaled by a factor of one minus the third parameter (kₒ),
wherein the method further comprises:
tuning the third equivalent inductance (L_{eq3}) and the fourth equivalent inductance (L_{eq4}) so that the third equivalent inductance (L_{eq3}) and the fourth equivalent inductance (L_{eq4}) are less than or equal to a self-inductance (L_{ref}) of a reference inductor.

16. The method of claim 14, further comprising:
determining, for the first equivalent inductance (L_{eq1}) and the second equivalent inductance (L_{eq2}), a plurality of values at the plurality of steady states; and
tuning the first equivalent inductance (L_{eq1}) and the second equivalent inductance (L_{eq2}) so that the first equivalent inductance (L_{eq1}) and the second equivalent inductance (L_{eq2}) are greater than or equal to a self-inductance (L_{ref}) of a reference inductor.

17. The method of claim 14, further comprising:
determining, for the first equivalent inductance (L_{eq1}) and the second equivalent inductance (L_{eq2}), a plurality of values at the plurality of steady states; and
tuning the first equivalent inductance (L_{eq1}), the second equivalent inductance (L_{eq2}), the third equivalent inductance (L_{eq3}), and the fourth equivalent inductance (L_{eq4}) to satisfy:
a self-inductance (L_{ref}) of a reference inductor is greater than or equal to the third equivalent inductance (L_{eq3}) and the fourth equivalent inductance (L_{eq4}); and
the self-inductance (L_{ref}) of the reference inductor is less than or equal to the first equivalent inductance (L_{eq1}) and the second equivalent inductance (L_{eq2}).

18. The method of claim 16, wherein determining, for the first equivalent inductance (L_{eq1}) and the second equivalent inductance (I_{eq2}), the plurality of values at the plurality of steady states further comprises:
determining, for the first equivalent inductance (L_{eq1}) and the second equivalent inductance (L_{eq2}), a first set of values of the plurality of values across the plurality of steady states when a duty cycle is greater than or equal to 0.5; and
determining, for the first equivalent inductance (L_{eq1}) and the second equivalent inductance (L_{eq2}), a second set of values of the plurality of values across the plurality of steady states when the duty cycle is less than 0.5.

19. The method of claim 12, wherein the coupling device comprises a single magnetic core.

20. The method of claim 12, wherein the coupling device comprises a first magnetic core and a second magnetic core,
wherein the first output terminal is connected to the first magnetic core, and the second output terminal is connected to the second magnetic core.
